(19) United States
(12) Patent Application Publication
(10) Pub. No.: US 2006/0268181 A1
(43) Pub. Date: Nov. 30, 2006

(54) Shot-cut detection

(75) Inventors: Fabian Edgar Ernst, Eindhoven (NL); Jan Alexis Daniel Nesvadba, Eindhoven (NL)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS N.V. GROENEWOUDSEWEG 1, 5621 BA EINDHOVEN (NL)

(21) Appl. No.: 10/545,652

(22) PCT Filed: Feb. 13, 2004
(86) PCT No.: PCT/IB04/50111

§ 371 Date: Aug. 16, 2005

(30) Foreign Application Priority Data
Feb. 21, 2003 (EP) 03100419.5

(51) Int. Cl. H04N 5/14; H04N 9/64

(52) U.S. Cl. 348/700; 348/699

(57) ABSTRACT

A method of detecting a shot-cut in a sequence of video images on basis of a first set of segments (S1n-1, S2n-1, S3n-1 and S41-1) and a second set of segments (S1n, S2n, S3n and S4n) being determined by means of segmentation, comprises: creating a third set of segments (S1n, S2n-1, S3n-1 and S4n-1) on basis of the first set of segments (S1n-1, S2n-1, S3n-1 and S4n-1); computing a consistency measure C(n-1, n) on basis of a number of values representing overlap (A,ij) between respective pairs of segments, each pair off segments comprising one of the segments (Sjn-1) of the third set of segments and one of the segments (Sin) of the second set of segments; and comparing the consistency measure (C(n-1, n)) with a predetermined threshold (Tc,) and establishing that the shot-cut is detected if the consistency measure (C(n-1, n)) is below the predetermined threshold (Tc).

The invention relates to a method of detecting a shot-cut in a sequence of video images.

The invention further relates to a shot-cut detector for detecting a shot-cut in a sequence of video images. The invention further relates to an image processing apparatus comprising:

a receiving means for receiving a signal corresponding to a sequence of video images;

a shot-cut detector for detecting a shot-cut in the sequence of video images; and

an image processing unit being controlled by the shot-cut detector.

The invention further relates to a computer program product to be loaded by a computer arrangement, comprising instructions to detect a shot-cut in a sequence of video images.

With the increase of available digital video content, high-level applications such as indexing, video-on-demand, digital libraries and content analysis require the partitioning of the complete video sequence into a number of scenes and/or shots. A scene comprises one or multiple shots. During the acquisition of a shot the camera stands still or optionally it moves continuously, while acquiring images of the same scene. A shot-cut detector is arranged to indicate the boundaries of a shot. Other video processing applications can also benefit strongly from shot-cut detection, e.g.:

Video compression, i.e. encoding or decoding, e.g. according to the MPEG standard. By knowledge of shot-cuts it is possible that each first frame of a shot is coded as I-frame (reference frame);

Scene classification, i.e. determination of type of video content, e.g. sports-game or movie or cartoon. Proper shot-cut detection avoids noise in the shot- or scene-based analysis;

2D-to-3D content conversion. The segmentation and camera calibration/depth estimation process should be reinitiated after a shot-cut.

Various types of shot-cut detectors have been presented in literature. E.g. “Fast scene change detection using direct feature extraction from MPEG compressed video”, by S. W. Lee et al., in IEEE Transactions on Multimedia, 2: 240-254, 2000 and “A robust scene-change detection method for video segmentation”, by C. L. Huang, in IEEE Transactions on Circuits and Systems for Video Technology, 11:1281-1288, 2001. The known shot-cut detectors can be classified according to the features they use, e.g. color histograms, pixel value differences, motion vectors, or whether they are designed for the uncompressed or for the compressed (MPEG) domain.

Many shot-cut detectors rely on comparing statistical measures of a number of images, in order to find a location in the video sequence where there is a large dissimilarity between the set of images before that location and the set of images after that location. This statistical measure can be based either on local criteria, for instance a pixel-based image difference, or on global criteria, e.g. comparing color histograms. Recently, more attention is being paid to also detect gradual transitions, such as fading. See e.g. “A unified approach to scene change detection in uncompiessed and-compressed video”, by W. A. C. Fernando et al, in IEEE Transactions on Consumer Electronics, 46:769-779, 2001.

Pixel-based shot-cut detectors have the disadvantage that they are sensitive to noise and they have difficulties to handle motion, either caused by moving objects or by movement of the camera. On the other hand, histogram-based, global, shot-cut detectors are more robust but ignore the spatial distribution of the data within the image.

It is an object of the invention to provide a method of detecting a shot-cut of the kind described in the opening paragraph which is relatively robust.

This object of the invention is achieved in that the method of detecting a shot-cut in a sequence of video images, comprising a first image and a second image, the first image comprising a first set of segments being determined by means of segmentation and the second image comprising a second set of segments being determined by means of segmentation, comprises:

creating a third set of segments for the second image on basis of the first set of segments;

computing a consistency measure on basis of a number of values representing overlap between respective pairs of segments, each pair of segments comprising one of the segments of the third set of segments and one of the segments of the second set of segments; and

comparing the consistency measure with a predetermined threshold and establishing that the shot-cut is detected if the consistency measure is below the predetermined threshold.

A difference with known methods of detecting a shot-cut is that segments of images are compared with each other instead of a priori known groups of pixels. In other words, in the method according to the invention segments are compared with each other which are related to the image content, since the segments are determined by means of a segmentation. That means that in the method according to the invention, the consistency measure is based on comparing geometrical structures, i.e. representations of objects within the images. If it appears that there is a relatively strong relation between objects being represented in the first image and objects being represented in the second image then the probability is relatively high that the first and second image belong to the same shot. However, if it appears that there is a relatively weak relation between objects being represented in the first image and objects being represented in the second image then the probability is relatively low that the first and second image belong to the same shot and hence belong to different shots. That means that there is a shot-cut between the first and second image.

Preferably the creation of the third set of segments is performed on basis of motion vectors being estimated for the respective segments of the first set of segments. An advantage of this embodiment according to the invention is that it is robust for image sequences with relatively much motion.

In an embodiment of the method according to the invention, a first one of the values representing overlap between respective pairs of segments is computed by means of counting the number of pixels which belong to a first one of the segments of the second set of segments and belong to a first one of the segments of the third set of segments. An advantage of this embodiment according to the invention is that counting pixels which belong to two segments is relatively easy.

An alternative for counting is that weighting factors are applied for the pixels which belong to two segments. The robustness is increased by applying weighting factors which are derived from the pixel values of the first and/or second image.

In an embodiment of the method according to the invention, in which weighting factors are applied, a first one of the values representing overlap between respective pairs of segments is computed by means of accumulation of weighted values, a first one of the weighted values related to a difference between a first luminance value of a first pixel of the first one of the segments of the second set of segments and a second luminance value of a second pixel of the first image, the first pixel also belonging to the first one of the segments of the third set of segments. The first pixel and the second pixel might have mutually equal coordinates but preferably the first and second pixel are estimated to be corresponding to the same scene point. In other words, there is a motion vector which represents the relation between the first and second pixel.

In another embodiment of the image processing apparatus according to the invention, in which weighting factors are applied, a first one of the values representing overlap between respective pairs of segments is computed by means of accumulation of weighted values, a first one of the weighted values related to a difference between a first color value of a first pixel of the first one of the segments of the second set of segments and a second color value of a second pixel of the first image, the first pixel also belonging to the first one of the segments of the third set of segments. The first pixel and the second pixel might have mutually equal coordinates but preferably the first and second pixel are estimated to be corresponding to the same scene point. In other words, there is a motion vector which represents the relation between the first and second pixel.

An embodiment of the method according to the invention, comprises determining the respective pairs of segments by means of selecting the pairs of segments from a set of pairs of segments on basis of the respective values representing overlap. The consistency measure is based on those pairs of segments which are most likely corresponding. Being corresponding means that the amount of overlap is relatively high compared with other pairs of segments which comprise the same segment. That means that the pairs of segments being applied to compute the consistency measure have to be selected form a larger set of possible pairs of segments.

In embodiment of the method according to the invention a first one of the set of pairs of segments, comprising a first one of the segments of the third set of segments and a first one of the segments of the second set of segments, is selected if the corresponding value of overlap is larger than:

further values of overlap corresponding to further pairs of segments, each comprising the first one of the segments of the third set of segments and a further segment which is not the first one of the segments of the second set of segments; and larger than

other values of overlap corresponding to other pairs of segments, each comprising the first one of the segments of the second set of segments and an other segment which is not the first one of the segments of the third set of segments.

An advantage of this embodiment according to the invention is that only relevant pairs of segments are used. Non related pairs of segments are disregarded for the summation.

In an embodiment of the method according to the invention, the predetermined threshold is based on the number of segments of the first set of segments. If the number of segments increases the size of the segments will logically decrease. This will result in more border areas around the segments with a low probability to find a good match. An increase in the number of segments will result in a decrease of the overlap probability. This knowledge is applied to make the predetermined thresholds for the shot-cut depended on the number of segments, i.e. average size of segments.

In an embodiment of the method according to the invention, the predetermined threshold is based on the motion vectors. If the amount of motion is high then the average size of occlusions is also relatively high. Occlusions reduce the overlap ratio, because logically no match can be found. Besides that, an increase in motion will result in a lower probability of correct motion estimation.

Alternatively the predetermined threshold is based on the amount of texture, i.e. average homogeneity. The texture is used to segment the image. Fuzzy texture will lead to unstable segmentation, which will decrease the consistency measure. The predetermined threshold of the shot cut detector might be texture/homogeneity-dependent.

It is a further object of the invention to provide a shot-cut detector of the kind described in the opening paragraph which is relatively robust.

This object is achieved in that the shot-cut detector for detecting a shot-cut in a sequence of video images, comprising a first image and a second image, the first image comprising a first set of segments being determined by means of segmentation and the second image comprising a second set of segments being determined by means of segmentation, comprises:

creating means for creating a third set of segments for the second image on basis of the first set of segments;

computing means for computing a consistency measure on basis of a number of values representing overlap between respective pairs of segments, each pair of segments comprising one of the segments of the third set of segments and one of the segments of the second set of segments; and

comparing means for comparing the consistency measure with a predetermined threshold and establishing that the shot-cut is detected if the consistency measure is below the predetermined threshold.

It is a further object of the invention to provide an image processing apparatus comprising a shot-cut detector of the kind described in the opening paragraph which is relatively robust.

This object is achieved in that the shot-cut detector for detecting a shot-cut in a sequence of video images, comprising a first image and a second image, the first image comprising a first set of segments being determined by means of segmentation and the second image comprising a second set of segments being determined by means of segmentation, comprises:

creating means for creating a third set of segments for the second image on basis of the first set of segments;

computing means for computing a consistency measure on basis of a number of values representing overlap between respective pairs of segments, each pair of segments comprising one of the segments of the third set of segments and one of the segments of the second set of segments; and

comparing means for comparing the consistency measure with a predetermined threshold and establishing that the shot-cut is detected if the consistency measure is below the predetermined threshold.

In an embodiment of the image processing apparatus according to the invention, the image processing unit is arranged to perform video compression. In another embodiment of the image processing apparatus according to the invention the image processing unit is arranged to perform scene classification.

It is a further object of the invention to provide a computer program product of the kind described in the opening paragraph which is relatively robust.

This object is achieved in that the computer program product for detecting a shot-cut in a sequence of video images, comprising a first image and a second image, the first image comprising a first set of segments being determined by means of segmentation and the second image comprising a second set of segments being determined by means of segmentation, after being loaded, provides processing means with the capability to carry out:

creating a third set of segments for the second image on basis of the first set of segments;

computing a consistency measure on basis of a number of values representing overlap between respective pairs of segments, each pair of segments comprising one of the segments of the third set of segments and one of the segments of the second set of segments; and

comparing the consistency measure with a predetermined threshold and establishing that the shot-cut is detected if the consistency measure is below the predetermined threshold.

Modifications of the method and variations thereof may correspond to modifications and variations thereof of the shot-cut detector, the image processing apparatus and of the computer program product described.

These and other aspects of the method and of the shot-cut detector, the image processing apparatus and of the computer program product according to the invention will become apparent from and will be elucidated with respect to the implementations and embodiments described hereinafter and with reference to the accompanying drawings, wherein:

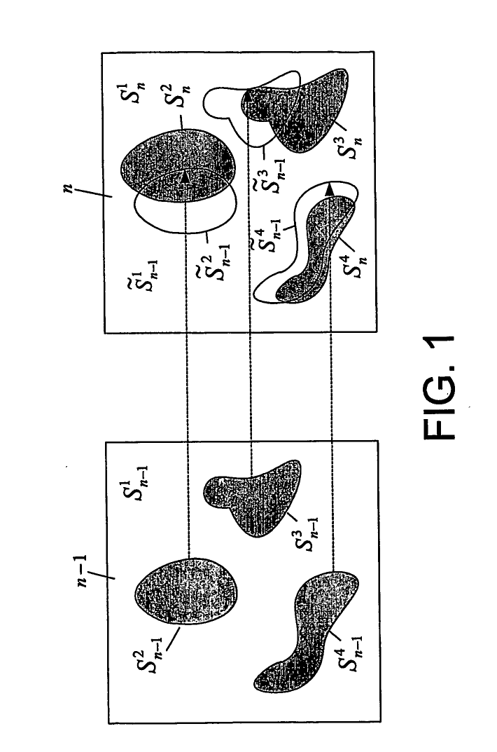

FIG. 1 schematically shows a first image with a first set of segments and a second image with a second set of segments and a third set of segments;

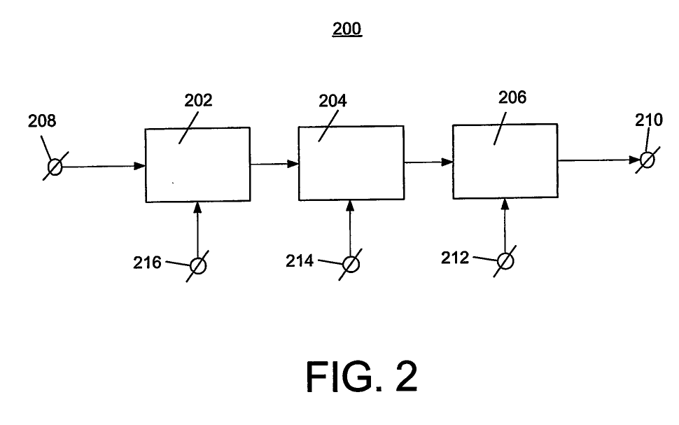

FIG. 2 schematically shows a shot-cut detector according to the invention;

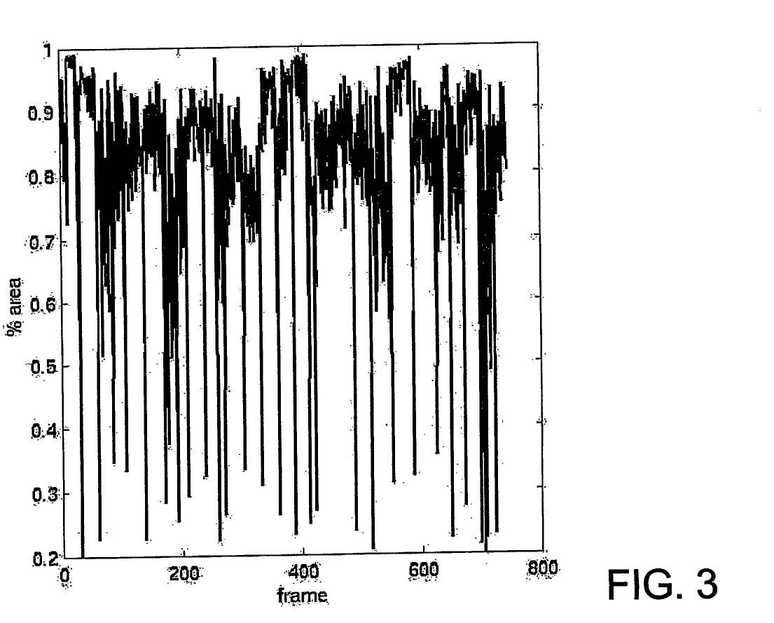

FIG. 3 schematically shows a consistency measure being computed according to the invention as function of image number for a music video clip; and

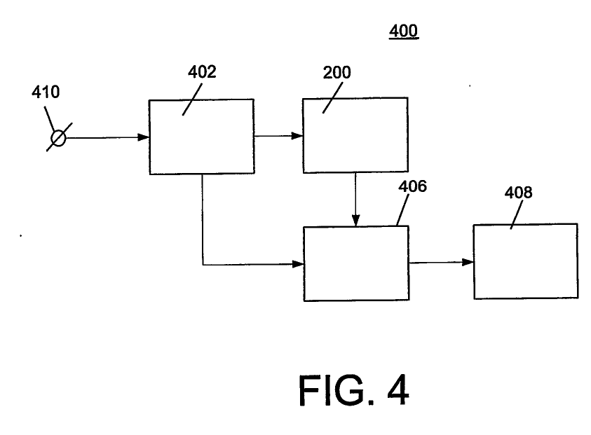

FIG. 4 schematically shows an image processing apparatus according to the invention.

Same reference numerals are used to denote similar parts throughout the figures.

FIG. 1 schematically shows a first image n-1 with a first set of segments Sₙ₋₁¹, Sₙ₋₁², Sₙ₋₁³ and Sₙ₋₁⁴ and a second image n with a second set of segments Sₙ¹, Sₙ², Sₙ³ and Sₙ⁴. The second image n also comprises a third set of segments \tilde{S}ₙ₋₁¹, \tilde{S}ₙ₋₁², \tilde{S}ₙ₋₁³ and \tilde{S}ₙ₋₁⁴. The segments \tilde{S}ₙ₋₁¹, \tilde{S}ₙ₋₁², \tilde{S}ₙ₋₁³ and \tilde{S}ₙ₋₁⁴ of the third set of segments are based on the segments Sₙ₋₁¹, Sₙ₋₁², Sₙ₋₁³ and Sₙ₋₁⁴, respectively. That might mean that the corresponding segments, e.g. Sₙ₋₁¹ and \tilde{S}ₙ₋₁¹, comprise corresponding pixels of the respective images n-1 and n. In this case a segment of the third set can be seen as a direct projection of a segment of the first set into the second image. Alteratively two corresponding segments have equal size and shape but they do not comprise corresponding pixels. In that case a segment of the third segment is based on a projected segment of the first set, which is shifted with a vector which represents the motion vector which has been estimated for that segment of the first set.

It should be noted that image n-1 might be preceding or succeeding image n in the sequence of video images.

FIG. 2 schematically shows a shot-cut detector 200 according to the invention. The shot-cut detector 200 is arranged to detect a shot-cut in a sequence of video images on basis of segments being found by means of segmentation. The segmentation might be performed by means of a segmentation unit (not depicted) which is part of the shot-cut detector. Alternatively the segmentation is performed externally and the segments are provided at the input connector 208 of the shot-cut detector. The segments can be represented by means of contour descriptions of the segments. Alternatively the segments are represented by means of matrices. A first set of segments corresponds to a first image of the sequence of video images, and a second set of segments corresponds to a second image of the sequence of video images.

The shot-cut detector 200 comprises:

a set creator 202 for creating a third set of segments \tilde{S}ₙ₋₁¹, \tilde{S}ₙ₋₁², \tilde{S}ₙ₋₁³ and \tilde{S}ₙ₋₁⁴. for the second image on basis of the first set of segments Sₙ₋₁¹, Sₙ₋₁², Sₙ₋₁³ and Sₙ₋₁⁴. The creation of segments can be based on a direct projection of the segments of the first set. Preferably, the creation is also based on the motion vectors being estimated for the segments of the first set and being provided by means of the input connector 216;

a consistency measure computing unit 204 for computing a consistency measure C(n-1, n) on basis of a number of values representing overlap Aᵢⱼ between respective pairs of segments, each pair of segments comprising one of the segments \tilde{S}ₙ₋₁^{j} of the third set of segments and one of the segments Sₙⁱ of the second set of segments;

a comparing unit 206 for comparing the consistency measure C(n-1, n) with a predetermined threshold T_{c} and establishing, at output connector 210, that the shot-cut is detected if the consistency measure C(n-1, n) is below the predetermined threshold T_{c} The predetermined threshold T_{c} is provided by means of the input connector 212.

The set creator 202, the consistency measure computing unit 204 and the comparing unit 206 may be implemented using one processor. Normally, these functions are performed under control of a software program product. During execution, normally the software program product is loaded into a memory, like a RAM, and executed from there. The program may be loaded from a background memory, like a ROM, hard disk, or magnetically and/or optical storage, or may be loaded via a network like Internet. Optionally an application specific integrated circuit provides the disclosed functionality.

The working of the shot-cut detector 200 is explained below by means of an example. For each pair of segments consisting of one segment Sₙⁱ of the current image n and one segment \tilde{S}ₙ₋₁^{j} derived from a segment Sₙ₋₁^{j} of the previous image n-1, the value representing overlap Aᵢⱼ is computed. This is done by counting pixels with coordinates \vec{x}=(x, y) of image n which belong to both segments Sₙⁱ and \tilde{S}ₙ₋₁^{j}, as specified in Equation 1

$${A}_{ij} = {\sum }_{\vec{x} ∈ n}^{} \{ 1 \vert \vec{x} ∈ {\tilde{S}}_{n - 1}^{j} ⋀ \vec{x} ∈ {S}_{n}^{i} \} \qquad ( 1 )$$

If this is done for all segments Sₙⁱ and \tilde{S}ₙ₋₁^{j} of both sets of segments, i.e. the second and the third set of segments, respectively, a matrix A is established. The elements of the matrix A correspond to the respective values representing Aᵢⱼ. From this matrix A, so-called corresponding segments are selected. That means that particular pairs of segments are selected from the total set of segments. A particular pair of segments, comprising a first one of the segments \tilde{S}ₙ₋₁^{j} of the third set of segments and a first one of the segments Sₙⁱ of the second set of segments, is selected if the corresponding value representing overlap Aᵢⱼ is larger than:

further values of overlap corresponding to further pairs of segments, each comprising the first one of the segments of the third set of segments and a further segment which is not the first one of the segments of the second set of segments; and larger than

other values of overlap corresponding to other pairs of segments, each comprising the first one of the segments of the second set of segments and an other segment which is not the first one of the segments of the third set of segments.

In other words, the segments are called corresponding if Aᵢⱼ is the biggest element in both column i and row j. This means that Sₙⁱ is the biggest segment overlying \tilde{S}ₙ₋₁^{j} and \tilde{S}ₙ₋₁^{j} the biggest segment overlying Sₙⁱ.

The consistency measure C(n-1, n) is computed by means of summation of the values representing overlap corresponding to the selected pairs of segments. For an example, see Table 1.

TABLE 1
Example values representing overlaps
between respective pairs of segment

| | Sₙ¹ | Sₙ² | Sₙ³ | Sₙ⁴ |
|---|---|---|---|---|
| \tilde{S}ₙ₋₁¹ | 100 | 300 | 10 | 0 |
| \tilde{S}ₙ₋₁² | 25 | 75 | 3 | 2 |
| \tilde{S}ₙ₋₁³ | 0 | 0 | 400 | 10 |
| \tilde{S}ₙ₋₁⁴ | 0 | 0 | 10 | 65 |

It appears that the following pairs of corresponding segments are selected:
(Sₙ²,\tilde{S}ₙ₋₁¹), (Sₙ³,\tilde{S}ₙ₋₁³) and (Sₙ⁴,\tilde{S}ₙ₋₁⁴). The respective values of overlap are: A₂₁=300, A₃₃=400 and A₄₄=65. Notice that some segments are not selected at all, e.g. Sₙ¹ and \tilde{S}ₙ₋₁². That means that no corresponding segments could be found.

The consistency measure C(n-1, n) is computed by means of summation of the values of overlap of the pairs of corresponding segments. Hence,

C(n-1, n) equal 765 (−300+400+65).

Preferably the normalized consistency measure \overline{C}(n-1, n) is computed by means of division by the number of pixels N ε n, i.e. the number of pixel of image n.

$$\overline{C} ( n - 1 , n ) = \frac{C ( n - 1 , n )}{N} \qquad ( 2 )$$

The values of the normalized consistency measure \overline{C}(n-1, n) are in the range [0,1].

The value of the normalized consistency measure \overline{C}(n-1, n) is compared with a predetermined threshold T_{c} to detect the shot-cut: If \overline{C}(n-1,n)<T_{c} then there is a shot-cut between image n-1 and n. A typical value for T_{c} is 0.4.

In another embodiment, the predetermined threshold T_{c} is not fixed, but differs per image pair. This floating predetermined threshold T_{c}(n) can be based on a running average of the consistency measure: A shot-cut is detected if the current value of the consistency measure is significantly below its average. After each detected shot-cut, the running average is reset.

The decisive parameter for the shot-cut is the relative overlap of segments of image n-1 and of segments of image n in comparison to the overall number of pixels in the images. The overlap increases if the number of matching pixels of image n-1 and image n can be increased. Motion estimation and compensation is a possible improvement to achieve better matching results. The motion compensation is done before matching the segments of image n-1 and image n. That means that the segments of the third set of segments are based on the segments of the first set of segments and the respective motion vectors of these segments. This reduces the influence of motion on the matching results. Hence the robustness is increased when motion estimation and compensation is applied.

In another embodiment according to the invention the values representing overlap are based on the values of the pixels of the images n-1 and n. That means that the values are computed by means of summation of weighting factors w(\vec{x}) per pixel:

$${A}_{ij}^{′} = {\sum }_{\vec{x} ∈ n}^{} \{ w ( \vec{x} ) \vert \vec{x} ∈ {\tilde{S}}_{n - 1}^{j} ⋀ \vec{x} ∈ {S}_{n }^{i} \} \qquad ( 3 )$$

Examples of weighting factors w(\vec{x}) are given by Equation 4-7.
w(\vec{x})=|F_{L}(\vec{x},n-1)−F_{L}(\vec{x},n) (4)
or
w(\vec{x})=|F_{L}(\tilde{x},n-1)−F_{L}(\vec{x},n) (5)
with F_{L}(\vec{x},n)the luminance value of the pixel with coordinates \vec{x} in image n and \tilde{x} is the estimated coordinate of \vec{x} on basis of the motion vector.
w(\vec{x})=|F_{C}(\vec{x},n-1)−F_{C}(\vec{x},n)| (6)
or
w(\vec{x})=|F_{C}(\tilde{x},n-1)−F_{C}(\vec{x}, n)| (7)
with F_{C}(\vec{x}, n) the color value of the pixel with coordinates \vec{x} in image n.

The luminance or color values are provided by means of the input connector 214.

Optionally an additional normalization is performed by means of dividing the computed values representing overlap by a value which is related to the maximum difference between two luminance or color values.

If the segmentation takes place in a video encoder the consistency measure might be computed also by the video encoder. Then a representation of the consistency measure can be inserted into the compressed stream as well (one value between 0 and 1 per frame, so for instance 8 extra bits per frame would suffice). Note that no decision on a predetermined threshold has to be made at the encoding side. With this approach, shot-cut detection can be done in the compressed domain by an apparatus which is designed to receive the compressed stream.

FIG. 3 schematically shows a consistency measure being computed according to the invention as function of image number for a music video clip. The x-axis represents the image (frame) number and the y-axis represents the consistency measure. By applying a predetermined threshold T_{c}=0.4 the shot-cuts can be detected. It should be noted that the actual number of shot-cuts in a video sequence can be relatively high. In this example of video material, comprising 720 images there are 30 shot-cuts.

FIG. 4 schematically shows an image processing apparatus 400 according to the invention. The image processing apparatus 400 comprises:

receiving means 402 for receiving a signal representing input images.

the shot-cut detector 200 as described in connection with FIG. 2;

an image processing unit 406 being controlled by the shot-cut detector; and

a display device 408 for displaying the output images of the image processing unit 406.

The signal may be a broadcast signal received via an antenna or cable but may also be a signal from a storage device like a VCR (Video Cassette Recorder) or Digital Versatile Disk (DVD). The signal is provided at the input connector 410. The image processing apparatus 400 might e.g. be a TV. Alternatively the image processing apparatus 400 does not comprise the optional display device 408 but provides the output images to an apparatus that does comprise a display device. Then the image processing apparatus 400 might be e.g. a set top box, a satellite-tuner, a VCR player, a DVD player or recorder. Optionally the image processing apparatus 400 comprises storage means, like a hard-disk or means for storage on removable media, e.g. optical disks. The image processing apparatus 400 might also be a system being applied by a film-studio or broadcaster.

The image processing unit 406 might support one or more of the following types of image processing:

Video compression, i.e. encoding or decoding, e.g. according to the MPEG standard.

De-interlacing: Interlacing is the common video broadcast procedure for transmitting the odd or even numbered image lines alternately. De-interlacing attempts to restore the full vertical resolution, i.e. make odd and even lines available simultaneously for each image;

Image rate conversion: From a series of original input images a larger series of output images is calculated. Output images are temporally located between two original input images; and

Temporal noise reduction. This can also involve spatial processing, resulting in spatial-temporal noise reduction.

For all these types of image processing it is relevant to divide the sequence of incoming video images into sub-sequences, since combining non-related images in these types of image processing might result in artifacts.

It should be noted that the method and detector according to the invention can be applied to detect different types of shot-cuts in video sequences. These shot-cuts include hard cuts but also soft-cuts: so-called wipe, fade-in, fade-out or dissolves. That means e.g. that images of a first shot and images of a second shot are partly mixed.

It should be noted that the above-mentioned embodiments illustrate rather than limit the invention and that those skilled in the art will be able to design alternative embodiments without departing from the scope of the appended claims. In the claims, any reference signs placed between parentheses shall not be constructed as limiting the claim. The word ‘comprising’ does not exclude the presence of elements or steps not listed in a claim. The word “a” or “an” preceding an element does not exclude the presence of a plurality of such elements. The invention can be implemented by means of hardware comprising several distinct elements and by means of a suitable programmed computer. In the unit claims enumerating several means, several of these means can be embodied by one and the same item of hardware.

1. A method of detecting a shot-cut in a sequence of video images, comprising a first image (n-1) and a second image (n), the first image comprising a first set of segments (Sₙ₋₁¹, Sₙ₋₁², Sₙ₋₁³ and Sₙ₋₁⁴) being determined by means of segmentation and the second image comprising a second set of segments (Sₙ¹, Sₙ², Sₙ³ and Sₙ⁴) being determined by means of segmentation, the method comprising:
creating a third set of segments (\tilde{S}ₙ₋₁¹, \tilde{S}ₙ₋₁², \tilde{S}ₙ₋₁³ and \tilde{S}ₙ₋₁⁴) for the second image on basis of the first set of segments (Sₙ₋₁¹, Sₙ₋₁², Sₙ₋₁³ and Sₙ₋₁⁴);
computing a consistency measure C(n-1, n) on basis of a number of values representing overlap (Aᵢⱼ) between respective pairs of segments, each pair of segments comprising one of the segments (\tilde{S}ₙ₋₁^{j}) of the third set of segments and one of the segments (Sₙ¹) of the second set of segments; and
comparing the consistency measure (C(n-1, n)) with a predetermined threshold (T_{c}) and establishing that the shot-cut is detected if the consistency measure (C(n-1,n)) is below the predetermined threshold (T_{c}).

2. A method as claimed in claim 1, wherein the creation of the third set of segments (\tilde{S}ₙ₋₁¹, \tilde{S}ₙ₋₁², \tilde{S}ₙ₋₁³ and \tilde{S}ₙ₋₁⁴) is performed on basis of motion vectors being estimated for the respective segments of the first set of segments (Sₙ₋₁¹, Sₙ₋₁², Sₙ₋₁³ and Sₙ₋₁⁴).

3. A method as claimed in claim 1, wherein a first one of the values representing overlap (A₁₁) between respective pairs of segments is computed by means of counting the number of pixels which belong to a first one (Sₙ¹) of the segments of the second set of segments and belong to a first one (\tilde{S}ₙ₋₁¹) of the segments of the third set of segments.

4. A method as claimed in claim 1, wherein a first one of the values representing overlap between respective pairs of segments is computed by means of accumulation of weighted values, a first one of the weighted values related to a difference between a first luminance value of a first pixel of the first one of the segments of the second set of segments and a second luminance value of a second pixel of the first image, the first pixel also belonging to the first one of the segments of the third set of segments.

5. A method as claimed in claim 1, wherein a first one of the values representing overlap between respective pairs of segments is computed by means of accumulation of weighted values, a first one of the weighted values related to a difference between a first color value of a first pixel of the first one of the segments of the second set of segments and a second color value of a second pixel of the first image, the first pixel also belonging to the first one of the segments of the third set of segments.

6. A method as claimed in claim 1, comprising determining the respective pairs of segments by means of selecting the pairs of segments from a set of pairs of segments on basis of the respective values representing overlap.

7. A method as claimed in claim 6, wherein a first one of the set of pairs of segments, comprising a first one of the segments of the third set of segments and a first one of the segments of the second set of segments, is selected if the corresponding value of overlap is larger than:
further values of overlap corresponding to further pairs of segments, each comprising the first one of the segments of the third set of segments and a further segment which is not the first one of the segments of the second set of segments; and larger than
other values of overlap corresponding to other pairs of segments, each comprising the first one of the segments of the second set of segments and an other segment which is not the first one of the segments of the third set of segments.

8. A method as claimed in claim 1, wherein the predetermined threshold is based on the number of segments of the first set of segments.

9. A method as claimed in claim 2, wherein the predetermined threshold is based on the motion vectors.

10. A shot-cut detector (400) for detecting a shot-cut in a sequence of video images, comprising a first image (n-1) and a second image (n), the first image comprising a first set of segments (Sₙ₋₁¹, Sₙ₋₁², Sₙ₋₁³ and Sₙ₋₁⁴) being determined by means of segmentation and the second image comprising a second set of segments (Sₙ¹, Sₙ², Sₙ³ and Sₙ⁴) being determined by means of segmentation, the shot-cut detector comprising:
creating means (202) for creating a third set of segments (\tilde{S}ₙ₋₁¹, \tilde{S}ₙ₋₁², \tilde{S}ₙ₋₁³ and \tilde{S}ₙ₋₁⁴) for the second image on basis of the first set of segments (Sₙ₋₁¹, Sₙ₋₁², Sₙ₋₁³ and Sₙ₋₁⁴);
computing means (204 for computing a consistency measure (C(n-1, n)) on basis of a number of values representing overlap (Aᵢⱼ) between respective pairs of segments, each pair of segments comprising one of the segments (\tilde{S}ₙ₋₁^{j}) of the third set of segments and one of the segments (Sₙⁱ) of the second set of segments; and
comparing means (206) for comparing the consistency measure (C(n-1, n)) with a predetermined threshold (T_{c}) and establishing that the shot-cut is detected if the consistency measure (C(n-1,n)) is below the predetermined threshold (T_{c}).

11. An image processing apparatus (400) comprising:
a receiving means (402) for receiving a signal corresponding to a sequence of video images;
a shot-cut detector (200) for detecting a shot-cut in the sequence of video images, as claimed in claim 1; and
an image processing unit (406) being controlled by the shot-cut detector.

12. An image processing apparatus (400) as claimed in claim 11, characterized in that the image processing unit is arranged to perform video compression.

13. An image processing apparatus (400) as claimed in claim 11, characterized in that the image processing unit is arranged to perform scene classification.

14. A computer program product to be loaded by a computer arrangement, comprising instructions to detect a shot-cut in a sequence of video images, comprising a first image and a second image, the first image comprising a first set of segments being determined by means of segmentation and the second image comprising a second set of segments being determined by means of segmentation, the computer arrangement comprising processing means and a memory, the computer program product, after being loaded, providing said processing means with the capability to carry out:
creating a third set of segments (\tilde{S}ₙ₋₁¹, \tilde{S}ₙ₋₁², \tilde{S}ₙ₋₁³ and \tilde{S}ₙ₋₁⁴) for the second image on basis of the first set of segments (Sₙ₋₁¹, Sₙ₋₁², Sₙ₋₁³ and Sₙ₋₁⁴);
computing a consistency measure C(n-1, n) on basis of a number of values representing overlap (Aᵢⱼ) between respective pairs of segments, each pair of segments comprising one of the segments (\tilde{S}ₙ₋₁^{j}) of the third set of segments and one of the segments (Sₙⁱ) of the second set of segments; and
comparing the consistency measure (C(n-1, n)) with a predetermined threshold (T_{c}) and establishing that the shot-cut is detected if the consistency measure (C(n-1, n)) is below the predetermined threshold (T_{c}).
